(19) United States
(12) Patent Application Publication
(10) Pub. No.: US 2006/0012996 A1
(43) Pub. Date: Jan. 19, 2006

(54) Solar light apparatus

(75) Inventor: Chien-Chuan Tseng, Taipei Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Art Mark International Corporation

(21) Appl. No.: 10/875,991

(22) Filed: Jun. 24, 2004

(51) Int. Cl. F21V 33/00

(52) U.S. Cl. 362/253

(57) ABSTRACT

A solar light apparatus has a protective cover, a base housing and a brick. Solar cells and a recharging circuit are placed on the base housing. The solar cells provide energy for recharging a rechargeable battery using the recharging circuit. When the night comes, a light source, e.g. an LED, coupled to the recharging circuit provides illumination automatically. The solar light apparatus can be easily installed on ground of gardens or garages easily and arranged to any pattern that users want to have.

### BACKGROUND OF THE INVENTION

1. Field of Invention

The present invention relates to a light apparatus, particularly to an embeddable solar light apparatus.

2. Description of Related Art

There are various types of lights for illuminating particular areas. Some lights are designed to facilitate reading while some are used for guiding people in the dark. Even though it has been such a long time since the first bulb appeared in the world, people still keep developing various new lights to make life better.

In real applications, different problems arise and responsive solutions are designed. For example, in garages or gardens, lights are usually exposed to sunlight, rain, or even snow. Therefore, durable structures are necessary. Waterproof capability is another issue when lights are to be installed near or on the ground, particularly when electric lines are buried under ground to provide power. In addition, placement of switches at proper locations sometimes decides whether it is convenient to use the lights. To maintain normal operations of lights is just another problem. Conventionally, it needs careful consideration and expensive labor to install lights in the right places. Many people find that it is too difficult or costly when they try to place or change the lights in their gardens or garages.

Therefore, a light apparatus that is easy to install and maintain while having a durable structure will bring further convenience to human life.

### SUMMARY OF THE INVENTION

An objective of the present invention is to provide a light apparatus that is easy to install and maintain in places like garages and gardens. A preferred embodiment according to the present invention to achieve the objective is a solar light apparatus that includes a protective cover, a base housing, at least one solar cell, at least one light source, and a recharging circuit.

The protective cover has at least one first transparent window and at least one second transparent window. The base housing has at least one cavity and at least one supporting area. The base housing is attached to a first surface of the protective cover. The solar cell is mounted on the supporting area of the base housing facing the first transparent window. The light source, e.g. an LED, is fixed in the cavity facing the second transparent window. A recharging circuit is coupled to the solar cell and the light source for recharging a rechargeable battery using power supplied by the solar cell so that the rechargeable battery is capable of driving the light source to provide illumination.

As an example for implementing the preferred embodiment, the protective cover is composed of a stainless plate and a plastic plate. Silicon rings are also applied for providing waterproof capability.

With the present invention, users do not need to consider complicated layout of electric wiring again. The solar light apparatus of the present invention can be placed in garages or gardens for any pattern of arrangement. It is also easy to maintain such solar light apparatus. Hence, the present invention may improve human life.

### BRIEF DESCRIPTION OF THE DRAWINGS

The accompanying drawings are included to provide further understanding of the invention, and constitute a part of this specification. The drawings illustrate the embodiments of the invention and, together with the description, serve to explain the principles of the invention. In the drawings,

FIG. 1 is an exploded view illustrating a preferred embodiment according to the present invention;

FIG. 2 is a top view of a portion of the preferred embodiment;

FIG. 3 is a side view of the portion of the preferred embodiment;

FIG. 4 is a perspective view of the portion of the preferred embodiment;

FIG. 5 is a side sectional view of the portion of the preferred embodiment;

FIG. 6 is a top view of the preferred embodiment; and

FIG. 7 is a side sectional view of the preferred embodiment.

### DESCRIPTION OF PREFERRED EMBODIMENT

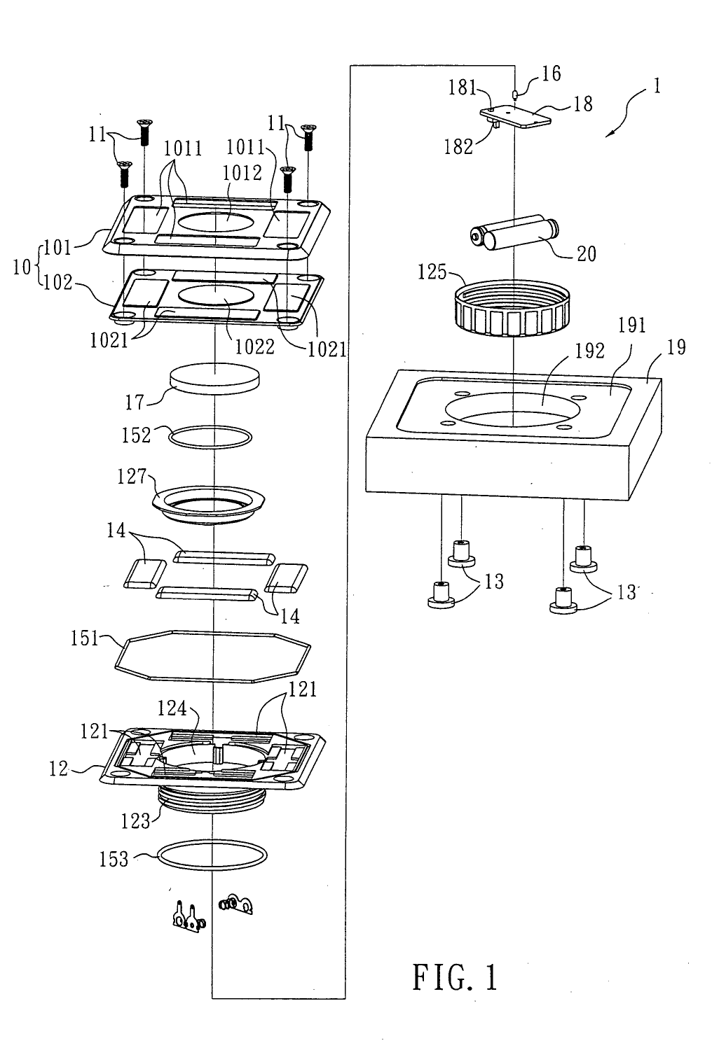

FIG. 1 is an exploded view illustrating a preferred embodiment according to the present invention. The preferred embodiment is a solar light apparatus 1 including a protective cover 10, a base housing 12, solar cells 14, a light source 16, and a recharging circuit 18.

The protective cover 10 is composed of a stainless plate 101 and a plastic plate 102. Two first transparent windows 1011 and 1021 are formed on the stainless plate 101 and the plastic plate 102. In addition, two other second transparent windows 1012 and 1022 are also formed on the stainless plate 101 and the plastic plate 102. The base housing 12 has a cavity 124 and supporting areas 121. The base housing 12 is attached to a first surface of the protective cover 10. Solar cells 14 are mounted on the supporting areas 121 of the base housing 12 facing the first transparent windows 1011 and 1021. The light source 16, e.g. an LED (Light Emitting Diode), is fixed in the cavity 124 facing the second transparent windows 1012 and 1022, and the recharging circuit 18 is coupled to the light source 16 and the solar cells 14 for recharging rechargeable batteries 20 using power supplied by the solar cells 14 so that the rechargeable batteries 20 are capable of driving the light source 16 to provide illumination.

In addition, the solar light apparatus has a brick 19 having a holding base 191 for holding the base housing 12. An opening 192 of the brick 19 is patterned to surround and protect a box 123 of the base housing 12 while the holding base 191 supports a plate portion of the base housing 12. A cap 125 is used for sealing the box 123 and is detachable from the box 123 for replacing the rechargeable batteries 20. If a switch 182 is optionally placed on the recharging circuit, the switch 182 can be used for turning on the recharging circuit 18. Also, a sensor 181, e.g. a light sensor, is optionally installed on the recharging circuit 18 to determine whether it is a proper time to turn on the light source 16. Further, a lens 17 that is made of hard glass is placed between the cavity of the base housing 12 and the second transparent windows 1012 and 1022 for protecting or focusing the light emitted from the light source 16.

To provide waterproof capability, a first silicon ring 151 is placed between the protective cover 10 and the base housing 12 for surrounding the solar cells 14. A second silicon ring 152 is placed on a part 127 of the base housing 12 for surrounding the cavity 124. In addition, a third silicon 153 is placed for surrounding the rim of the cap 125.

It is easy to assemble the solar light apparatus 1 by using screws 11 and 13. Then, users only need to place one or more such solar light apparatuses 1 on the ground of their gardens or garages. With the solar light apparatus 1, users do not need to consider complicated layout of electric wiring. They can arrange a plurality of such solar light apparatuses 1 to form any pattern they like. Also, users do not need to turn on the lights when the night comes. The solar cells 14 can save solar energy in daytime and recharge the rechargeable batteries 20. When the night comes, the rechargeable circuit 18 turns on the light source 16 to provide illumination. Maintenance of the solar light apparatus is also easy. Since the brick 19 is not tied to any electric line, what users need to do is to take up the brick 19 and unscrew the cap 125 of the base housing 12 for replacing the rechargeable batteries 20 or the light source 16.

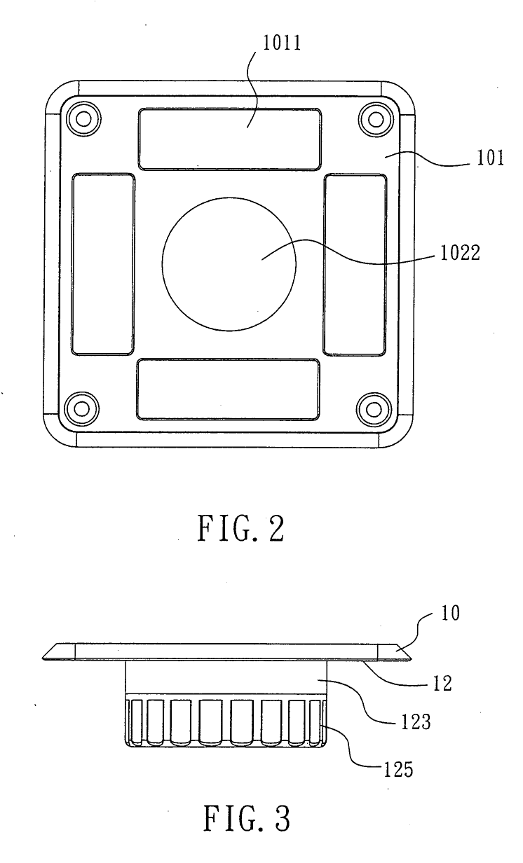

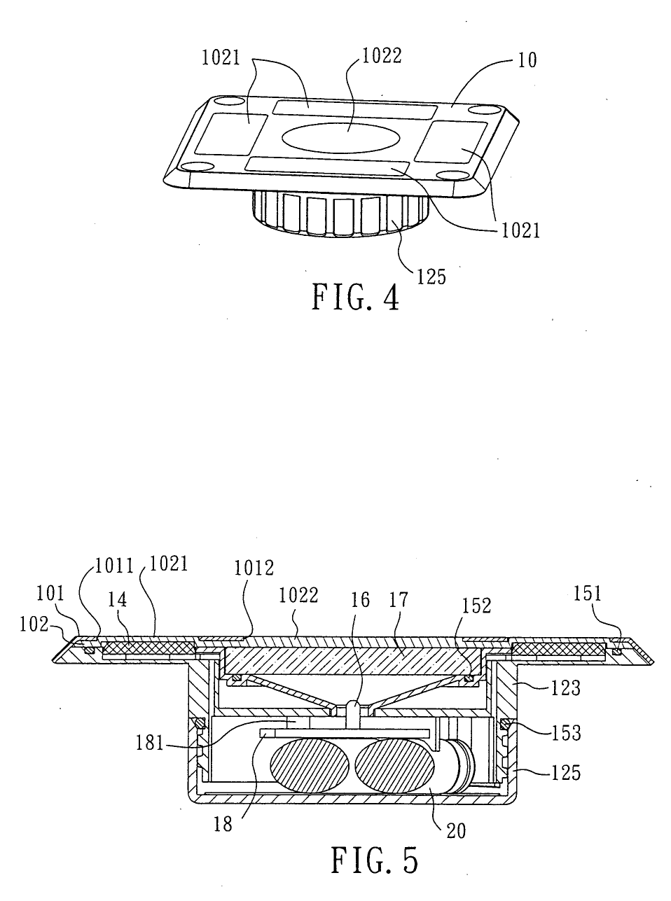

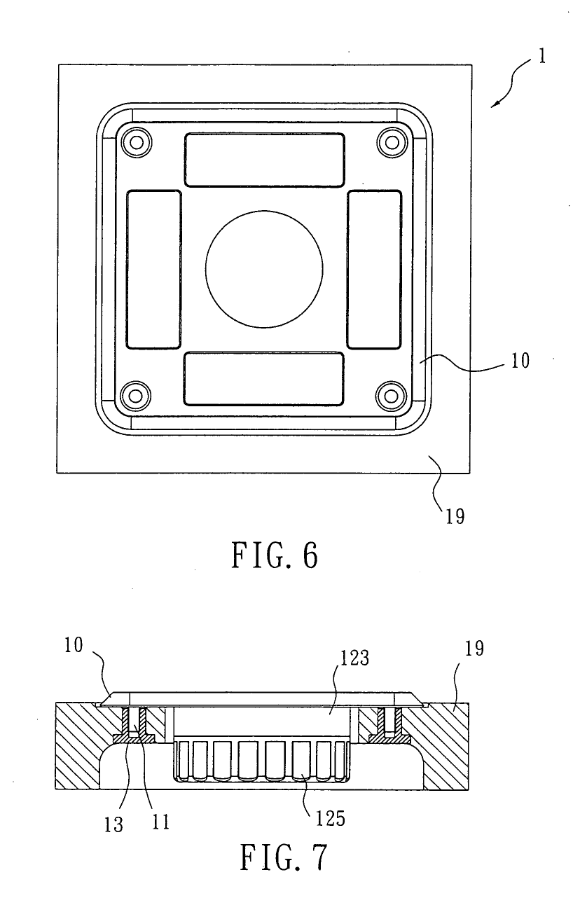

To provide a clearer explanation, FIG. 2 and FIG. 3, respectively, illustrate a top view and a side view of the base housing 12 and the protective cover 10. In addition, FIG. 4 is a perspective view of FIG. 3 and FIG. 5 is a sectional view of FIG. 3. Further, FIG. 6 and FIG. 7 are a top view and a side sectional view, respectively, for illustrating the supporting housing 12 placed on the brick 19.

Although the present invention is described using the above embodiments, it does not mean that the scope of the present invention is limited to the above description. Persons skilled in the art can make all kinds of modifications, for example, changing the selected polymeric material, introducing different conductive particles, changing electroplating conditions, changing constituent weight ratio, to achieve the same effects. However, these modifications shall not deviate from the spirit of the present invention, and they shall fall within the scope of protection of the present invention. The scope of protection of the present invention shall not be limited to the description of the claims.

What is claimed is:

1. A solar light apparatus, comprising:
a protective cover having at least one first transparent window and at least one second transparent window;
a base housing having at least one cavity and at least one supporting area, and being attached to a first surface of the protective cover;
at least one solar cell mounted on the supporting area of the base housing facing the first transparent window;
at least one light source fixed in the cavity facing the second transparent window; and
a recharging circuit coupled to the at least one solar cell and the at least one light source for recharging a rechargeable battery using power supplied by the at least one solar cell so that the rechargeable battery is capable of driving the at least one light source to provide illumination.

2. The solar light apparatus of claim 1, wherein a second surface of the protection cover is substantially a plane.

3. The solar light apparatus of claim 2, further comprising a brick having a holding base for holding the base housing.

4. The solar light apparatus of claim 3, wherein the brick is placed on the ground and the second surface of the protective cover faces upward from the ground.

5. The solar light apparatus of claim 3, further comprising screws for fixing the protective cover, the base housing, and the brick together.

6. The solar light apparatus of claim 1, further comprising a first silicon ring surrounding the solar cell and the silicon ring is placed between the protective cover and the base housing.

7. The solar light apparatus of claim 6, wherein the protective cover comprises a stainless plate and a plastic plate, and the plastic plate is placed between the stainless plate and the base housing.

8. The solar light apparatus of claim 1, further comprising a second silicon ring surrounding the cavity of the base housing.

9. The solar light apparatus of claim 1, wherein the light source is an LED.

10. The solar light apparatus of claim 1, furthering comprising a lens placed between the cavity of the base housing and the second transparent window.

11. The solar light apparatus of claim 1, wherein the recharging circuit has a switch, and the recharging circuit is activated when the switch is turned on.

12. The solar light apparatus of claim 1, wherein the base housing comprises a box for holding the recharging circuit and the rechargeable battery.

13. The solar light apparatus of claim 12, wherein the box of the base housing has a cap that is detachable from the box for replacing the rechargeable battery.

14. The solar light apparatus of claim 1o, wherein the box of the base housing further comprises a third silicon ring surrounding the rim of the cap.

15. The solar light apparatus of claim 1, further comprising a sensor installed on the rechargeable circuit to turn on the light source.
